(19) United States
(12) Patent Application Publication
(10) Pub. No.: US 2005/0212167 A1
(43) Pub. Date: Sep. 29, 2005

(54) Method for manufacturing a soft nozzle having preferred open status

(76) Inventor: Shih-Sheng Yang, Taipei Hsien (TW)

Correspondence Address: LEONG C LEI, PMB # 1008, 1867 YGNACIO VALLEY ROAD, WALNUT CREEK, CA, 94598, US

(21) Appl. No.: 10/810,556

(22) Filed: Mar. 29, 2004

(51) Int. Cl. B29C 45/14

(52) U.S. Cl. 264/154; 264/261

(57) ABSTRACT

A method for manufacturing a soft nozzle having a preferred open status includes fastening on the first mold post a threaded cover and at least a pair of combinative blocks; and disposing said first mold post along with the second mold post into the cave of a mother mold, such that an appropriate distance would exist between the tops of the first mold post and the second mold post. Therefore, when a soft plastic material is injected into the sprue of the mother mold and formed a pattern, the threaded cover would integrally combined with the combinative blocks to form a nozzle, the front of which will integrally formed with a binding cover, while the center of the nozzle would be cut to form at least one outlet crevice.

### BACKGROUND OF THE INVENTION

(a) Technical Field of the Invention

The present invention relates to a method for manufacturing a soft nozzle having a preferred open status, in particular to a method which can produce a novel nozzle, the interior flow path of which would not be hindered due to excessive pressure by the user's teeth at the time when the outlet crevice is pressed, and the width of the outlet crevice can widely expanded to allow the liquid to flow out easily. The product made according to the invention is adopted to a water bag for being carried outdoors with the user.

(b) Description of the Prior Art

Cycling has become a popular competitive sport, as well as a leisure activity. People usually need to replenish lost water due to sweating while cycling. The cyclist usually mounts a rack on a bicycle for holding the water bottle to solve the drinking issue during cycling. And, to make it convenient for the cyclist to drink water from the bottle on the bicycle, a conduit with nozzle may be provided on the cover of the bottle for drinking purposes, such that the cyclist can drink water during cycling, rather than stop to drink. However, given that a bottle usually cannot contain great volume of water, there is a limit of carrying enough water to go far.

When doing outdoor sports such as marathons, mountaineering, jungle adventures, etc. a person needs to prepare a lot of water for necessary use. Therefore, water bags which can carry a great volume of water with the a person for the purposes of relieving thirst have become popular in the market.

Regarding nozzle structures used in said water bags as disclosed in the U.S. Pat. Nos. 5,601,207, 5,730,336, 5,791,510, 6,032,831 and 6,070,767, the outer appearance of the nozzles are made by injection of single material such as safe PU or silicone. The front end of the nozzle has a single-line or cross shape water outlet crevice, the periphery of which is provided with a thick board, so that when the board is pressed to deform, the sidewalls of the fine outlet crevice can be squeezed by the natural retrived elasticity of the rather thick board, such that the outlet crevice can be closed to stop water.

When in use, the user holds the soft nozzle in the mouth and clenches the teeth and lips so as to press the water outlet crevice to be in an open status. Operating along with suction by mouth, the user can drink the water contained in the pouch.

Although soft nozzle of this type makes sucking easier without requiring much effort, water would leak from the nozzle simply due to accidental squeeze which makes the lips of the nozzle turn outside.

However, as the nozzles according to the prior art do not provide outlet crevices that can be closely shut, whenever the water bag is slightly pressed, the water would easily leak out of the water bag, thus a preferred status for stopping water can be obtained.

In view of the disadvantages of the above-mentioned nozzles, the inventor has researched and designed to disclose a method for manufacturing a soft nozzle having a preferred open status. Said nozzle is formed integrally without additional assembly, rendering the cost efficiently reduced. Accordingly, the motive contained in the invention is to bring profit to the consumers.

### SUMMARY OF THE INVENTION

The primary object of the present invention is to provide a method for manufacturing a soft nozzle having a preferred open status, which can make nozzles having tight binding force, such that when the water bag is pressed, the outlet crevice would not have the problem of leaking.

The secondary object of the present invention is to provide a soft nozzle, having a preferred open status, is formed integrally without additional assembly, rendering the cost efficiently reduced.

Yet a further object of the invention is to provide a method for manufacturing a soft nozzle, the interior flow path of which would not be hindered due to overly bite by the user, such that the water can flow out with great volume easily.

To obtain the above-mentioned object, the present invention discloses a method for manufacturing a soft nozzle having a preferred open status, which includes fastening on the first mold post a threaded cover and at least a pair of combinative blocks; and disposing said first mold post along with the second mold post into the cave of a mother mold, such that an appropriate distance would exist between the tops of the first mold post and the second mold post. Therefore, when a soft plastic material is injected into the sprue of the mother mold and formed a pattern, the threaded cover would integrally combined with the combinative blocks to form a nozzle, the front of which will integrally formed with a binding cover, while the right center of the nozzle would be cut to form at least one outlet crevice.

The nozzle produced according to the above steps can be combined to the water conduit of a water bag by way of the interior threads in the threaded cover at the bottom nozzle. Besides, the binding cover at the top of the nozzle structure can be turned over such that the binding cover can tightly bind outside of the front end of the nozzle structure to closely shut the outlet crevice and prevent leaking at the time when the water bag is pressed. Furthermore, while combinative blocks are provided at two sides of the nozzle wall, when the nozzle is pressed, the combinative blocks will make the board outward, thereby expanding the outlet crevice crosswise and obtaining the greatest width of the opened outlet crevice to ease the liquid contained in the water bag be sucked out. When the pressure disappears, the outlet crevice will be tightly bond by the elasticity of the turned over binding cover, thereby avoiding the liquid from flowing out of the water bag.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart showing the process of the present invention.

FIG. 2 shows steps a) and b) of the present invention.

FIG. 3 show steps c) and d) of the present invention.

FIG. 4 is a cut-away view of a product made according to the invention wherein said product has just been detached from the mold.

FIG. 5 is a perspective view of a product made according to the invention; the outlet crevice has been well cut.

FIG. 6 shows the product made according to the invention in a ready-for-use state.

FIG. 7 is a cut-away view showing the use status of the product made according to the invention.

FIG. 8 is a perspective view of the product shown in FIG. 7.

FIG. 9 is a cross-sectional view of the product made according to the invention in a status of being held by teeth.

FIG. 10 is a front view of the product made according to the invention in a status of being squeezed.

FIG. 11 is a cut-away view taken from 11-11 of FIG. 10.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

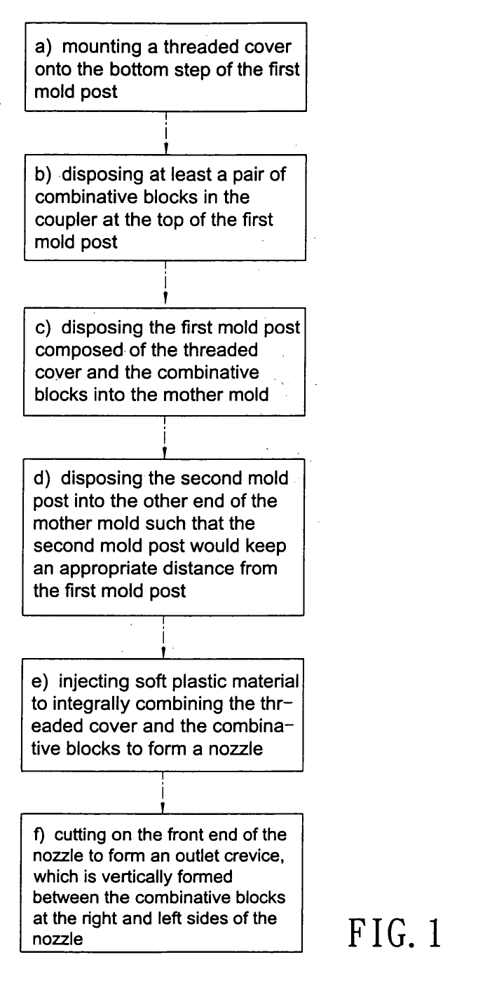

Referring to FIG. 1, the procedure of the invention includes the following steps:
a) mounting a threaded cover having interior threads onto the bottom step of the first mold post;
b) disposing at least a pair of combinative blocks in the coupler at the top of the first mold post;
c) disposing the first mold post composed of the threaded cover and the combinative blocks into the mother mold;
d) disposing the second mold post into the other end of the mother mold such that the second mold post and the first mold post would oppose to each other, and the tops thereof would keep an appropriate distance from each other;
e) injecting soft plastic material into the sprue of the mother mold, and integrally combining the threaded cover and the combinative blocks via melting, thereby accomplishing a nozzle, the front of which is integrally combined with a binding cover; and
f) cutting on the spaced surface at least one outlet crevice, which is vertically formed between the combinative blocks at the right and left sides of the nozzle.

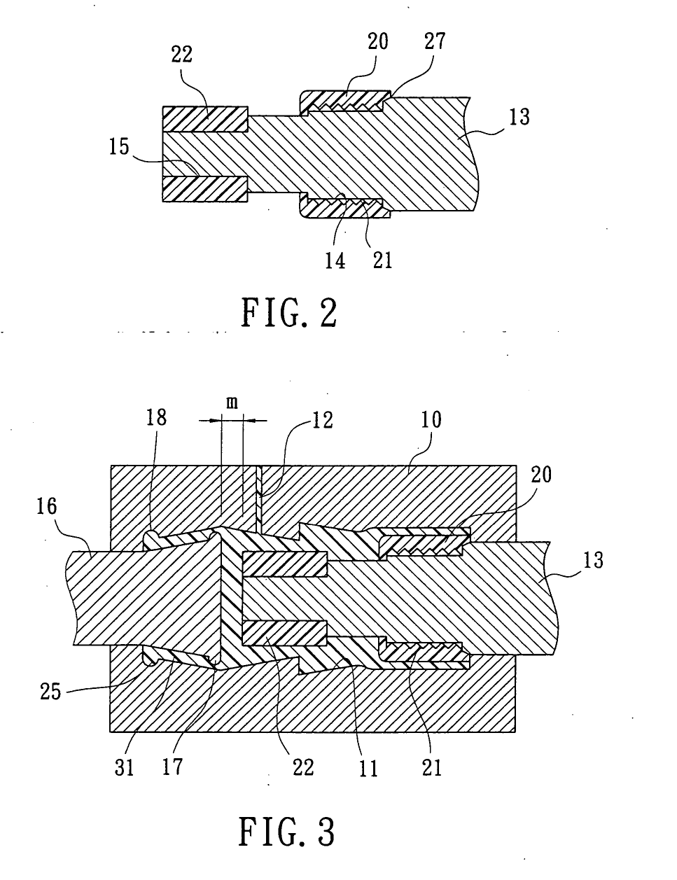

Referring to FIG. 2, the manufacture method of the invention is provided with a first mold post 13. Couplers 15 are provided on the top of the first mold post 13 at the left and right sides where correspond to each other (in the embodiment, each coupler is provided at each corresponding side). The couplers 15 are set as twin. The threaded cover 20 with interior threads 21 si mounted on the step 14 of the first mold post 13, such that the open end 27 of the threads will be sealed to refrain the injected material from flowing inside of the threaded cover 20.

Furthermore, the threaded cover 20 according to the invention can alternatively be substituted by a ratchet tube (not shown), one end of which is coated by soft plastic material, while the exposed ratchet tube section can be directly inserted into the water conduit of the water bag.

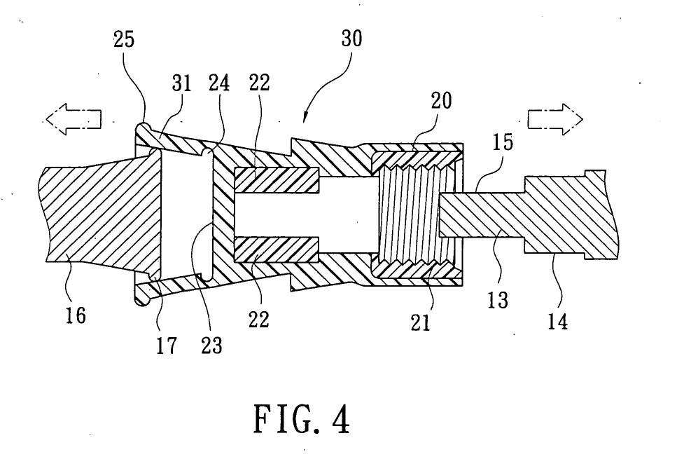

As shown in FIGS. 3 and 4, after disposing two combinative blocks 22 made of hard plastic material inside the coupler 15, the first mold post 13 is disposed in the cave 11 of the mother mold 10, while the second mold post 16 is disposed in the other end of the mold cave 11, such that an appropriate distance m will form between the tops of the second mold post 16 and the first mold post 13. In a preferred embodiment, the end of the second mold post 16 is gradually expanded and is provided with a flange 17. The end of the mold cave 11 adjacent to the second mold post 16 is provided with recession groove 18. After the soft plastic material injected into the mother mold 10 from the sprue 12 has cooled and formed a pattern, the threaded cover 20 will integrally combine with the combinative blocks 22 via hot melting with the soft plastic material, while the front of which is integrally combined with a binding cover 31. Subsequently, the first mold post 13 and second mold post 16 are removed from the mother mold 10, wherein the second mold post 16 is detached from the soft plastic material by force since the end thereof is in an expanded form, thereby accomplishing a nozzle 30 (as shown in FIG. 4).

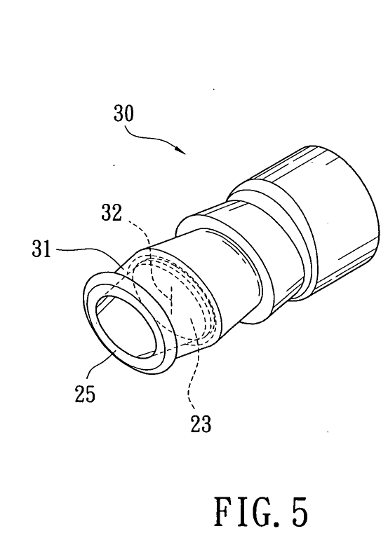

Referring to FIGS. 4 and 5, the front section of the nozzle 30 produced according to the above-mentioned steps will form a binding cover 31. As a distance m is provided between the tops of the first mold post 13 and second mold post 16, there will be formed a spaced surface 23 after injection. The spaced surface 23 will be cut to form a outlet crevice 32, which is vertically disposed between the left and right combinative blocks 22, such that the interior of the nozzle 30 can communicate with outside through the outlet crevice 32.

After injection to form a nozzle 30, the flange 17 provided at the end of the second mold post 16 can form a recession loop 24 at the position where the inside of the binding cover 31 connects to the spaced surface 23. And the mold cave 11 of the mother mold 10 is provided with a recession groove 18 at the end sides, which, after the soft plastic material is injected into the sprue 12 and cooled to form a pattern, will form an extruding loop 25 at the extended end of the binding cover 31.

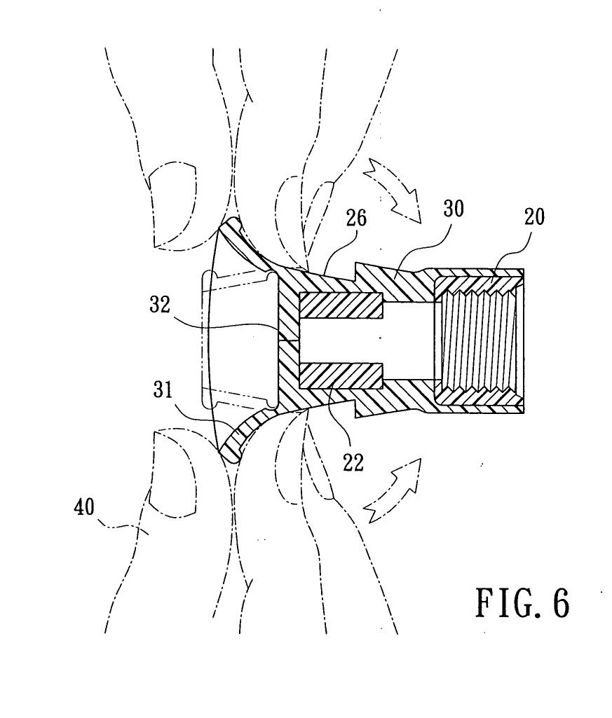

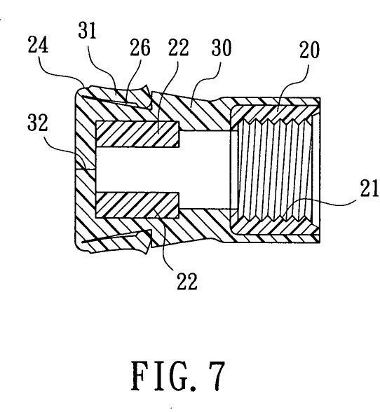

As shown in FIGS. 6 and 7, before using the nozzle, the user can screw the nozzle 30 to the water conduit of the water bag (not shown) by way of the interior threads 21 of the threaded cover 20 at the back of the nozzle 30. Subsequently, the binding cover 31 at the top of the nozzle 30 can be turned over by fingers 40 such that the binding cover 31 can just tightly bind the step 26 at the middle section of the nozzle 30. As the step 26 is provided outside of the two combinative blocks 22, the spaced surface 23 of the nozzle 30 where the outlet crevice 32 is provided can have better binding force, such that whenever the outlet crevice 32 is not pressed, the liquid would leak from it (as shown in FIG. 7).

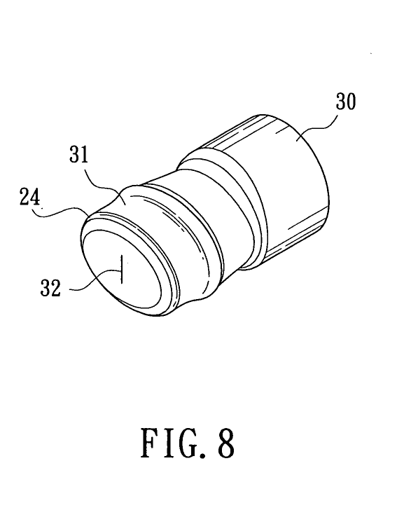

Referring to FIG. 8, after the steps illustrated in FIG. 6 have been accomplished, the integral appearance of the nozzle 30 would present as shown in FIG. 8. In addition, as a recession loop 24 is provided at the position where the interior surface of the binding cover 31 and the spaced surface 23, the binding cover 31 can be turned over neatly at the dented position where the material is thin, thereby the turned over binding cover 31 can perfectly fit. As the extruding loop 25 at the end of the binding cover 31 can efficiently bond and fastened to the step 26, the spaced surface 23 adjacent to the outlet crevice 32 can be provided with wall of the same width, unlike the nozzle of the prior art, in which the wall adjacent to the outlet crevice is rather thick.

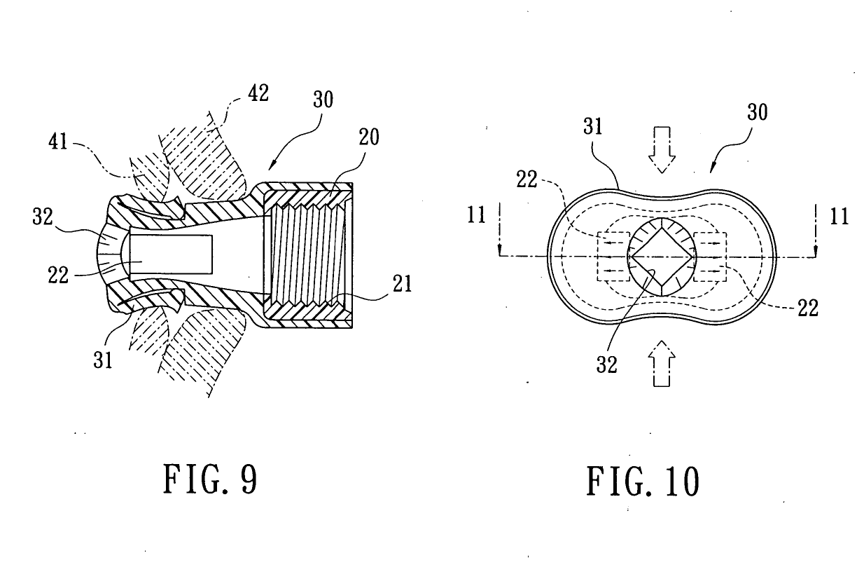

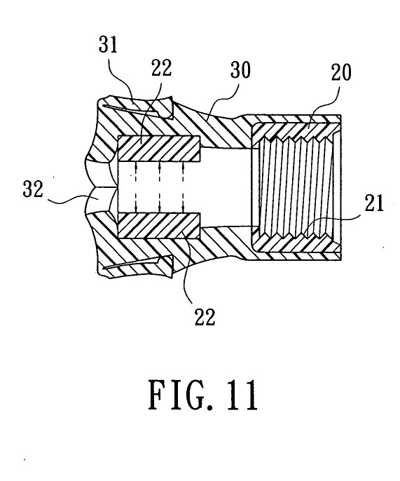

Referring to FIG. 9, when being in use, the nozzle 30 is disposed in the user's mouth and held by teeth 41 and lips 42. When the binding cover 31 at the front end of the nozzle 30 is held and pressed by the user's teeth 41, since the combinative blocks 22 correspondingly provided at the left and right sides of the wall of the nozzle 30 is integrally formed with the wall of the nozzle, as the nozzle 30 is pressed, the combinative blocks 22 at two sides would move horizontally. By way of the crosswise displacement of the combinative blocks 22, the displacement of the boards of the spaced surface 22 around the outlet crevice 32 will be strongly pulled outwards. As shown in FIGS. 10 and 11, the combinative blocks 22 will draw the boards around the outlet crevice 32 at the time when they are expanded outwards, thereby the outlet will extremely expand, such that the liquid contained in the water bag can be instantly and voluminously sucked out. Meanwhile, the ultimate biting force of the user's teeth 41 can be born by the combinative blocks 22, thus avoiding the space of the flow path inside of the nozzle 30 from overly sinking, and keeping the flow path unimpeded.

After finishing use of the nozzle, the user's teeth 41 and lips 42 would apart from the nozzle 30. After the applied pressure disappears, the spaced surface would be squeezed inwards by way of the recovered elasticity of the binding cover 31, thereby tightly binding the outlet crevice 32 to prevent the liquid leak out of the water bag.

In view of the above, the method for manufacturing a soft nozzle having a preferred open status according to the invention has the following advantages:

1. The threaded cover and combinative blocks mounted on the mobile mold posts can easily combine with the soft plastic material to form an integrity after the step of plastic injection.

2. The integrally formed nozzle is a single element, which need not be assembled by a number of elements, as is the prior art. Therefore, the manufacture procedure and costs can be efficiently reduced, and the tightness of the combination of the nozzle to the water bag can be increased.

3. There is an appropriate distance is provided between the first mold post and the second mold post. While injecting soft plastic material and forming a pattern, a binding cover will extend from the rim of the front end of the nozzle and can be turned over to tightly bind the front end of the nozzle, in order to increase the tightness of the outlet crevice and prevent the liquid form leaking out of the water bag.

4. The combinative blocks are integrally combined to the two sides of the interior flow path of the nozzle, such that when the nozzle is bitted, the sinking distance would effectively be controlled to keep the interior flow path impeded.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A method for manufacturing a soft nozzle having a preferred open status, including the following steps:
a) mounting a threaded cover having interior threads onto the bottom step of the first mold post;
b) disposing at least a pair of combinative blocks in the coupler at the top of the first mold post;
c) disposing the first mold post composed of the threaded cover and the combinative blocks into the mother mold;
d) disposing the second mold post into the other end of the mother mold such that the second mold post and the first mold post would oppose to each other, and the tops thereof would keep an appropriate distance from each other;
e) injecting soft plastic material into the sprue of the mother mold, and integrally combining the threaded cover and the combinative blocks via hot melting, thereby accomplishing a nozzle, the front of which is integrally combined with a binding cover; and
f) cutting on the spaced surface to form at least one outlet crevice, which is vertically formed between the combinative blocks at the right and left sides of the nozzle.

2. The method for manufacturing a soft nozzle having a preferred open status according to claim 1, wherein the couplers provided on the top of the mobile mold post are correspondingly arranged at the left and right sides of the mold post.

3. The method for manufacturing a soft nozzle having a preferred open status according to claim 1, wherein the end of the second mold post is gradually expanded.

4. The method for manufacturing a soft nozzle having a preferred open status according to claim 1, wherein the end of the second mold post is provided with a flange.

5. The method for manufacturing a soft nozzle having a preferred open status according to claim 1, wherein the end of the second mold post is provided with a recession groove.

6. The method for manufacturing a soft nozzle having a preferred open status according to claim 1, wherein the threaded cover can be alternatively substituted by a ratchet tube.
